(19) United States
(12) Patent Application Publication
(10) Pub. No.: US 2011/0121199 A1
(43) Pub. Date: May 26, 2011

(54) IMAGING APPARATUS FOR LOW-LIGHT SAMPLE

(75) Inventors: Yoshihisa TANIKAWA, Tokyo-to (JP); Masahiro Oba, Tokyo-to (JP); Yoshihiro Shimada, Tokyo-to (JP)

(73) Assignee: OLYMPUS CORPORATION, Tokyo (JP)

(21) Appl. No.: 12/952,387

(22) Filed: Nov. 23, 2010

(30) Foreign Application Priority Data
Nov. 24, 2009 (JP) 2009-266658

(51) Int. Cl. G01J 1/58

(52) U.S. Cl. 250/458.1; 250/208.1

(57) ABSTRACT

An imaging apparatus for low-light sample comprises: an image-forming optical system which includes an objective lens and an image-forming lens and forms the sample image of an sample having a point light source, where the point light source emits weak light including fluorescence; an illumination optical system which radiates light from an illumination light source to the sample to make the sample emit fluorescence; and an image capturing means which includes a plurality of pixels and captures the image corresponding to the sample image. The illumination optical system radiates light from the illumination light source to the sample with the light not traveling via the objective lens, the image-forming optical system is approximately telecentric and is provided with a filter which is arranged between the objective lens and the image forming lens and wavelength-selectively extracts fluorescence from the sample, and the image-forming optical system is formed in such a way that the image-forming optical system collects weak light from the point light source to form airy disks the sizes of which are is approximately the same as or smaller than the sizes of the pixels.

This application claims benefits of Japanese Patent Application No. 2009-266658 filed in Japan on Nov. 24, 2009, the contents of which are hereby incorporated by reference.

### BACKGROUND OF THE INVENTION

1. Field of the Invention

This invention relates to an imaging apparatus for low-light sample for capturing the image of a sample emitting weak light. In particular, this invention relates to an imaging apparatus for low-light sample which is suitable for capturing images of samples having a minute light-emitting source, such as samples emitting weak fluorescence and samples producing bioluminescence.

2. Description of the Related Art

In recent years, there is the increasing necessity to observe a cell of a living organism in such a way that a green fluorescent protein (GFP) or a luciferase gene which is a bioluminescence enzyme is made to work as a reporter of gene expression and a particular portion or a functional protein in the cell is fluorescently or luminescently labeled, in fields of research, such as cell biology and molecular biology.

In observation with GFP, the GFP is a protein which fluoresces in accordance with excitation-light radiation and fluorescence is obtained by radiating excitation light having large intensity to a sample on which the GFP is made to act, so that the sample is easy to damage and time to perform the observation with GFP is limited to about one to two hours. On the other hand, in observation with luciferase, the luciferase is an self-luminescent enzyme and the observation with luciferase does not require excitation light which damages a sample, so that it is possible to perform the observation with luciferase over a span of about five days.

On the other hand, in observation with GFP, it is possible to focus excitation light at one point of a sample using a confocal laser scanning microscope or the like to increase the luminous intensity of fluorescence, while, in observation with luciferase, a sample has to be observed with low-light which is emitted by the luciferase itself because the luminous intensity cannot be increased by excitation light.

In general, the widespread use for capture of low-light includes not only the use for observation with luciferase but also the uses for observation with weakened excitation light even in the case of using GFP, light metering for fluorescence from a DNA chip, a dark-field observation of the flagellum of a microorganism, and so on. Highly sensitive cooled CCD cameras for such uses have been actively developed.

Also, in the use for capture of low-light, an objective lens having a large numerical aperture is conventionally used for an optical system which forms the image of a sample, in order to collect more light from the sample. Besides, as some other constitution than the constitution in which a large NA is made on the sample side by the objective lens, it is also possible to use a constitution in which a demagnifying lens is arranged on the image side of an image-forming lens in a microscope to make the image forming-side NA large. However, the object of the other constitution is to make the size of a field of view in which a CCD captures an image correspond with the size of a field of view which is observed by visual observation, and is not aimed at an observation of low-light.

FIG. 1 is an explanatory view showing one example of an image-forming optical system in which a demagnifying lens is arranged. In the image-forming optical system which is shown as one example in FIG. 1, a demagnifying lens 104 is arranged in the space between an image-forming lens 103 and an image plane 106, where the space between the image forming lens 103 and the image plane 106 is the image space of an optical system consisting of an objective lens 102 and the image-forming lens 103, and the image-forming optical system becomes an image-forming optical system which is telecentric on the image side as a whole. When the lens 104 is not provided for the image-forming optical system, the images of an object point 101a on an sample 101 which is on the optical axis OA3 and an object point 101b on the sample 101 which is out of the optical axis OA3 are formed at an image point 106a and image point 106b on the image plane 106, respectively. On the other hand, when the lens 104 is provided for the image-forming optical system, the images of the object point 101a and object point 101b are formed at an image point 105a and image point 105b on the image plane 105, respectively. Also, in this example, the image at the image point 105b is formed in such a way that the height of the image point 105b is about half as high as the height of the image point 106b. Besides, the image-forming optical system is formed in such a way that the position and aperture of the exit pupil Pu of the image-forming optical system are unchanged regardless of whether the lens 104 is arranged in the image-forming optical system or not.

Also, the image-forming optical system, which is shown in FIG. 1 and is telecentric on the image side, is often used for a length measuring microscope or the like is conventionally and is used as an optical system essential to a CCD camera in recent years. An image-forming optical system which is telecentric on the image side is an optical system in which the exit pupil is located at infinity and chief rays emerging form the optical system to go to each of image points are parallel to the optical axis. Usually, in a CCD camera, as the angle of incidence of light to the image-pickup plane becomes larger, the sensitivity of a CCD camera reduces. Accordingly, uniform and highly sensitive capture of an image in the whole of the image-pickup plane requires chief rays of light entering each of pixels of the CCD camera which are made to become perpendicular to the image pickup plane, and an image-forming optical system which is telecentric on the image side is considered to be essential for the achievement of the chief rays perpendicular to the image pickup plane.

In addition to the above-described uses, an image-forming optical system which is telecentric on the image side is often used also for a microscope disclosed in Japanese Patent No. 2990871 or Japanese Patent Kokai No. 2000-235150.

A microscope disclosed in Japanese Patent No. 2990871 is provided with an optical means which can be changed into another one in accordance with a change in the exit pupil position accompanied by an exchange of object lenses, so that it is possible to keep the microscope telecentric on the image side even in the case where objective lenses are exchanged.

Also, in a microscope disclosed in Japanese Patent Kokai No. 2000-235150, the image pickup plane of a CCD camera is slanted somewhat with respect to the optical axis, so that it is possible to obtain a clear observation image without causing interference fringes on the image pickup plane even in the case where laser beams are used.

Besides, there is not only the development in highly sensitive CCD cameras but also the development in high resolution CCD cameras. For example, the development in high resolution CCD cameras has realized a high definition CCD camera the pixel size of which is 2 to 3 μm and which includes five million pixels. And, an apparatus which is called virtual slide is developed by combining such a high definition CCD camera with a microscope. In virtual slides, a sample is divided into a plurality of areas and the images of the areas are captured by the use of an image-forming optical system which magnifies an object about 20 times and in which field curvature and distortion are suppressed into small ones, in order to acquire a plurality of the images of the areas in advance, and then, after the acquired images are pieced together in the image data, the image which is optionally magnified about 5 to 100 times by electronic zoom is displayed on a monitor, where the electronic zoom is an electronic enlargement process. In this way, virtual slides are used as a teaching material for medical students because virtual slides make it possible to display the high definition image of a sample on a monitor even though neither actual microscope nor actual sample is present on that occasion.

Now, when a luciferase gene as a reporter gene is introduced into a cell and the expression intensity of the luciferase gene is examined by using as an indicator the amount of light emitting from the cell which results from luciferase activity, a target DNA fragment is linked to the upstream or downstream of the luciferase gene. This way makes it possible to examine an effect of the DNA fragment on the transcription of the luciferase gene. Also, if a gene such as a transcription factor which is believed to affect the transcription of the luciferase gene is linked to an expression vector and is co-expressed with the luciferase gene, it is possible to examine an effect of a gene product resulting from the co-expression on the expression of the luciferase gene.

Methods of introducing a reporter gene such as luciferase gene into a cell include the calcium phosphate method, the lipofectin method, the electroporation method, and so an. These methods are properly used in accordance with the object of introduction or types of cells. And, in determination of the amount of light emitting from a cell which results from luciferase activity, after a cell lysis solution is made to react with a substrate solution containing luciferin, ATP, and magnesium, the amount of light is determined by a luminometer with a photomultiplier tube. Because the amount of light is determined is after the lysis of the cell in this determination, the amount of the expression at some point in time is measured as the average of the whole of the cell.

Also, the amount of light emitting from a living cell has to be measured in time-sequentially order in order to grasp the time-dependent change in the amount of gene expression. For example, an incubator for incubating cells is given the function of luminometer and the amount of light emitting from all of incubated cells is measured at regular time intervals. As a result, it is possible to measure the expression rhythm which has regular periodicity, or the like. In this case, the time-dependent change in the expression amount in the whole of the cells is measured.

On the other hand, in the case where a gene expression is transient, expression amount widely varies with each of cells. For example, even in the case of incubated cells such as HeLa cell which are cloned, the response of a medicine through a receptor on the surface of a cell membrane may vary with each of the cells. That is to say, some cells of the cells may respond to it even though the response as the whole of the cells is not detected. In this case, it is important to measure the expression amount not in the whole of the cells but in each of the cells

Also, the amount of light emitting from a living cell is much too weak to observe light emitting from each cell with a microscope or the like. As a result, there is the problem that exposure taking a long time of about 30 minutes has to be performed using highly sensitive CCD cameras such as photon counting CCD camera and light-amplifying cooled CCD camera. One of solutions to the problem is suggested, for example, in an image pickup unit for low-light sample disclosed in WO 2006/088109.

An image pickup unit for low-light sample disclosed in WO 2006/088109 comprises: an image-forming optical system which forms the sample image of a sample having a point light source, where the point light source emits weak light such as light emission of a sample; and an image-capturing means which includes a plurality of pixels receiving incident light and captures the image corresponding to the sample image, wherein the is image-forming optical system is telecentric on the sample-image side of the image-forming optical system, and rays of weak light from the point light source are collected so as to form airy disks the sizes of which are approximately the same as or smaller than the size of each of the pixels in order to increase the amount of light received by one pixel and electromotive current of one pixel, so that it is possible to capture the image of the sample in a short exposure time with signal-to-noise ratio improved.

### SUMMARY OF THE INVENTION

An imaging apparatus for low-light sample according to the present invention is characterized in that the imaging apparatus comprises: an image-forming optical system which includes an objective lens and an image-forming lens and forms the sample image of an sample having a point light source, where the point light source emits weak light which at least includes fluorescence; a fluorescence excitation illumination optical system which radiates light emitted from an illumination light source to the sample to make the sample emit fluorescence; and an image capturing means which includes a plurality of pixels receiving incident light and captures the image corresponding to the sample image, wherein the fluorescence excitation illumination optical system is formed in such a way that the fluorescence excitation illumination optical system radiates light emitted from the illumination light source to the sample while the light from the illumination light source does not travel via the objective lens, the image-forming optical system is approximately telecentric and is provided with an emission filter, where the emission filter is arranged between the objective lens and the image forming lens and to wavelength-selectively extracts fluorescence emitted from the sample, and the image-forming optical system is formed in such a way that the image-forming optical system collects weak light emitted from the point light source to form airy disks the sizes of which are approximately the same as or smaller than the sizes of the pixels.

Also, in an imaging apparatus for low-light sample according to the present invention, is it is preferred that at least a part of the fluorescence excitation illumination optical system is arranged approximately on the optical axis of the image-forming optical system while an excitation filter is removably placed on the optical paths of the fluorescence excitation illumination optical system, where the excitation filter is capable of wavelength-selectively performing a photoexcitation in accordance with sample, and the image-forming optical system is formed in such a way that the emission filter is removably placed on the optical paths of the image-forming optical system

Also, in an imaging apparatus for low-light sample according to the present invention, it is preferred that the focal length of the image-forming lens is 65 mm or less.

According to the present invention, it is possible to obtain an imaging apparatus for low-light sample by which it is possible to perform fluorescence observation and light-emission observation using only the apparatus with the position of a sample unchanged, and, in addition, which is low in price and small with a common cooled CCD being used.

These features and advantages of the present invention will become apparent from the following detailed description of the preferred embodiment when taken in conjunction with the accompanying drawings.

### BRIEF DESCRIPTION OF THE DRAWINGS

FIG. 1 is an explanatory view showing one example of image-forming optical systems which is provided with a demagnifying and is telecentric on the image side.

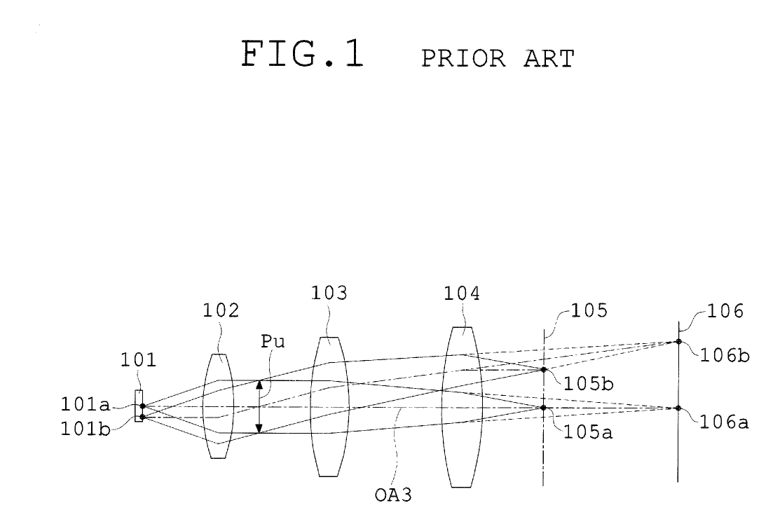

FIG. 2 is a schematic view showing the constitution of the whole of an imaging apparatus for low-light sample according to the first embodiment of the present invention.

### DETAILED DESCRIPTION OF THE PREFERRED EMBODIMENTS

The embodiment of the present invention is specifically explained using the drawings hereinafter.

### First Embodiment

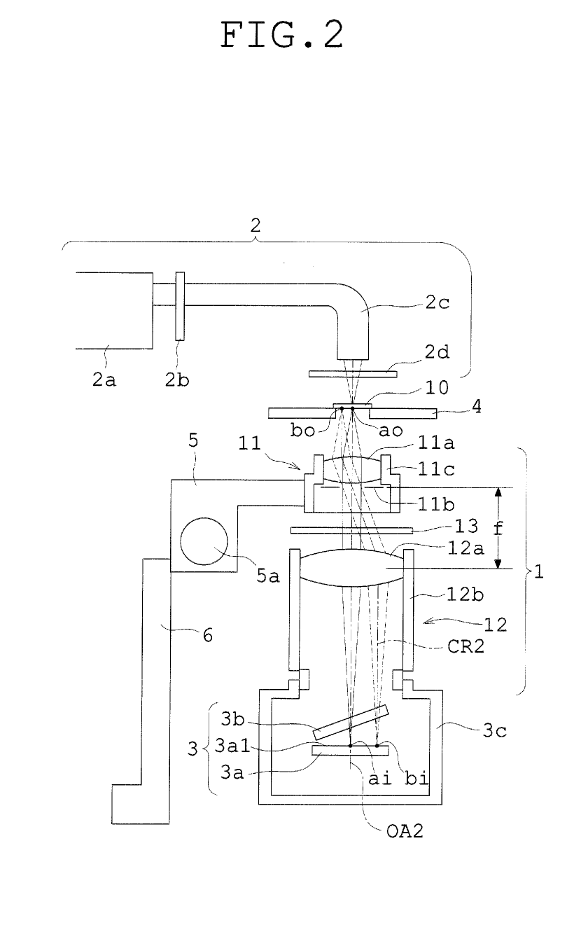

FIG. 2 is a schematic view showing the constitution of the whole of an imaging apparatus for low-light sample according to the first embodiment of the present invention.

The imaging apparatus for low-light sample according to the first embodiment is provided with: an image-forming optical system 1 which forms the sample image of a sample 10 having a point light source, where the point light source emits weak light at least containing fluorescence; a fluorescence excitation illumination optical system 2 which radiates light emitted from a light source to the sample 10 to make the sample 10 emit fluorescence; and a camera 3 as an image capturing means which receives incident light and captures the image corresponding to the sample image.

The image-forming optical system 1 includes an objective lens 11 and an image-forming lens 12 which are arranged along an optical axis OA2.

The objective lens 11 includes an optical lens 11a, an aperture stop 11b, and an objective-lens frame 11c. The optical lens 11a and the aperture stop 11b are held in the objective-lens frame 11c through calking or the like. The aperture stop 11b is formed to be a stop the aperture diameter of which is unchanged. Also, the objective lens 11 is formed as a lens system which is infinity corrected.

The image-forming lens 12 includes an optical lens 12a and an image-forming-lens frame 12b. The optical lens 12a is held in the image-forming-lens frame 12b through calking or the like.

Also, the image-forming optical system 1 is formed to be approximately telecentric.

Also, the image-forming optical system 1 is provided with an emission filter 13 which is arranged between the objective lens 11 and the image-forming lens 12. The emission filter 13 is characterized in that the emission filter 13 transmits only light rays having a desired fluorescence wavelength in light rays emitted from the sample 10 and cuts the other light rays, in particular, light rays having an excitation wavelength. Also, the emission filter 13 includes a plurality of wavelength absorption filters which are removably placed on optical paths between the objective lens 11 and the image-forming lens 12, for example, through a turret or slider and the wavelength-transmitting ranges of which are different from one another, so that the emission filter 13 can wavelength-selectively transmit only light having an aimed fluorescence wavelength in accordance with the sample 10.

Also, the image-forming optical system 1 is formed in such a way that the image-forming optical system 1 collects weak light emitted from the point light source on the sample 10 and forms airy disks the sizes of which are approximately the same as or smaller than the sizes of the pixels of the image pickup element 3. That is to say, the image-forming lens 12 is formed in such a way that the image-forming lens 12 forms airy disks which are inscribed in the light receiving areas of the pixels on an imaging plane 3a1, respectively, that is to say, the diameters of the airy disks are approximately the same as the sizes of the receiving areas in the pixels, respectively, so that the image of the point light source on the sample 10 is formed on the imaging plane 3a1.

The fluorescence excitation illumination optical system 2 includes an illumination light source 2a, an illumination light shutter 2b, an illumination fiber 2c, and an excitation filter 2d.

The illumination light source 2a radiates light in a wide wavelength range. The illumination light shutter 2b is formed in such a way that the opening and closing of the shutter can control a state where light is radiated or not radiated to the sample 10. The illumination fiber 2c is arranged so as to guide light emitted from the illumination light source 2a to the sample 10. And, the exit end of the illumination fiber 2c is arranged approximately on the optical axis OA2 of the image-forming optical system 1. The excitation filter 2d includes a plurality of wavelength absorption filters which are removably placed on optical paths of the fluorescence excitation illumination optical system 2, for example, through a turret or slider and the wavelength-transmitting ranges of which are different from one another, so that it is possible to perform a photoexcitation by the excitation filter 2d selecting a wavelength in accordance with the sample 10.

The camera 3 includes a CCD element 3a, an infrared light-cut filter 3b, and a camera housing 3c.

The camera housing 3c is fitted to the image-forming-lens frame 12b through screws which are provided in the ends of the housing and the frame respectively. An adjustment of length of the thread engagement makes it possible to adjust the distance between the image-forming lens 12 and the focal plane 3a1 of the CCD element 3a.

The sample 10 as a sample which has a point light source emitting weak light includes a slide glass holding a cell in which a luciferase is expressed and a localized potion of which is given fluorescence staining.

With regard to the other constitution, the reference numeral, “4”, in FIG. 2 stands for an XY stage, where the XY stage is used for arranging the sample 10 and making it possible to move the sample 10 in the two X-axis and Y-axis directions, so that the XY stage is used in aligning the sample 10 to a desired observation position. The reference numeral, “5” stands for a body stand.

The objective lens 11 is fitted to the body stand 5, so that the objective lens 11 can be moved in the direction perpendicular to the XY stage 4 by operating an operation dial 5a for changing position in the Z-axis direction. The reference numeral, “6” stands for a base stand for supporting the body stand 5.

First, the case of performing fluorescence observation using an imaging apparatus for low-light sample cell of the first embodiment with such a constitution is explained.

In the case of performing fluorescence observation, an observer operates so as to open the illumination light shutter 2b. As a result, light rays emitting from the illumination light source 2a and having a wide wavelength range enter the illumination fiber 2c. The light rays incident on the illumination-light-source-2a side end plane of the illumination fiber 2c (the entrance-side end) pass through the illumination fiber 2c, emerge from the sample-10 side end plane (the exit-side end) to the sample-10 side, and enter the excitation filter 2d. The excitation filter 2d transmits only light rays in the incident light rays, which have a wavelength corresponding to the filter performance of a selected wavelength absorption filter. And, fluorescent substances in the sample 10 are excited by the light rays which are transmitted by the excitation filter 2d, and the sample 10 emits fluorescence. The fluorescent rays having occurred from the sample 10 enter the optical lens 11a of the objective lens 11. The objective lens 11 is a lens system which is infinity corrected, captures the light ray from each of the point light sources on the sample 10 with numerical aperture NAo and telecentrically while the point light sources on the sample 10 are located at the front focal point positions of the objective lens 11 respectively, and changes the light rays into collimated light to emit the collimated light. Each of rays of the collimated light emerging from the objective lens 11 is focused on the aperture stop 11b which is arranged at the rear focal point position of the objective lens 11, forms an exit pupil, and enters the emission filter 13.

The emission filter 13 transmits only light rays in the light rays incident on the emission filter 13, which have a desired luminous wavelength for observation in accordance with the filter performance of a selected wavelength absorption filter. And, the other unnecessary light rays are cut by the emission filter 13. The light rays transmitted by the emission filter 13 enter the image-forming lens 12. The image-forming lens 12 is arranged in such a way that the front focal point position of the image-forming lens 12 corresponds to the exit pupil position on the aperture stop 11b. The image-forming lens 12 focuses each of rays of collimated light which has passed through the aperture stop 11b. And then, the image-forming lens 12 forms the image of the sample 10 on the imaging plane 3a1 of the CCD 3a which is perpendicular to the optical axis OA2, with numerical aperture NAi and telecentrically. In this case, the image-forming lens 12 corrects spherical aberration and astigmatism which occur by the infrared light cut filter 3b. In such a manner, the objective lens 11 and image-forming lens 12 collect light rays from point light sources ao and bo on the sample 10, and form an image at image points ai and bi on the imaging plane 3a1, respectively. In this case, the chief ray CR2 of light which forms an image at the image point bi is made to become parallel to the optical axis OA2 by the image-forming lens 12, and perpendicularly enters the imaging plane 3a1. Similarly, the chief ray of light which forms an image at each of the image points on the imaging plane 3a1 except for the image point bi is also made to become parallel to the optical axis OA2 by the image-forming lens 12, and perpendicularly enters the imaging plane 3a1.

Also, as described above, the image-forming lens 12 forms airy disks which are inscribed in the light receiving areas of the pixels on an imaging plane 3a1 respectively. That is to say, the image-forming lens 12 forms on the imaging plane 3a1 the images of the point light sources on the sample 10 in such a way that the diameters of the airy disks are approximately the same as the sizes of the receiving areas in the pixels respectively. As a result, in an imaging apparatus for low-light sample according to the present embodiment, it is possible to increase the amount of light received by one pixel and electromotive current of one pixel to capture the image of each of the point light sources on the sample 10 high-sensitively with signal-to-noise ratio improved.

The light rays having entered the CCD 3a are photo-electrically converted by the CCD 3a to be output as electronic data of the two-dimensional image which is an observation result, and the electronic data are sent to a personal computer which is not shown in the drawings and the image is displayed on a monitor which is not shown in the drawings.

Next, the case of performing light-emission observation using an imaging apparatus for low-light sample cell of the first embodiment with such a constitution is explained.

In the case of performing light-emission observation, an observer operates so as to close the illumination light shutter 2b. As a result, light rays emitting from the illumination light source 2a are not made to enter the sample 10, so that the sample 10 is in a state where only light rays emitted by the sample 10 itself exist without exciting fluorescence in the sample 10. The light rays emitting from the sample 10 enter the optical lens 11a of the objective lens 11. The objective lens 11 is a lens system which is infinity corrected, captures the light ray from each of the point light sources on the sample 10 with numerical aperture NAo and telecentrically while the point light sources on the sample 10 are located at the front focal point positions of the objective lens 11 respectively, and changes the light rays into collimated light to emit the collimated light. Each of rays of the collimated light emerging from the objective lens 11 is focused on the aperture stop 11b which is arranged at the rear focal point position of the objective lens 11, forms an exit pupil, and enters the emission filter 13.

The emission filter 13 transmits only light rays in the light rays incident on the emission filter 13, which have a desired luminous wavelength for observation in accordance with the filter performance of a selected wavelength absorption filter. And, the other unnecessary light rays are cut by the emission filter 13. The light rays transmitted by the emission filter 13 enter the image-forming lens 12. The image-forming lens 12 is arranged in such a way that the front focal point position of the image-forming lens 12 corresponds to the exit pupil position on the aperture stop 11b. The image-forming lens 12 focuses each of rays of collimated light which has passed through the aperture stop 11b. And then, the image-forming lens 12 forms the image of the sample 10 on the observation plane 3a1 of the CCD 3a which is perpendicular to the optical axis OA2, with numerical aperture NAi and telecentrically. In this case, the image-forming lens 12 corrects spherical aberration and astigmatism which occur by the infrared light cut filter 3b. In such a manner, the objective lens 11 and image-forming lens 12 collect light rays from point light sources ao and bo on the sample 10, and form an image at image points ai and bi on the imaging plane 3a1, respectively. In this case, the chief ray CR2 of light which forms an image at the image point bi is made to become parallel to the optical axis OA2 by the image-forming lens 12, and perpendicularly enters the imaging plane 3a1. Similarly, the chief ray of light which forms an image at each of the image points on the imaging plane 3a1 except for the image point bi is also made to become parallel to the optical axis OA2 by the image-forming lens 12, and perpendicularly enters the imaging plane 3a1.

Also, as described above, the image-forming lens 12 forms airy disks which are inscribed in the light receiving areas of the pixels on an imaging plane 3a1 respectively. That is to say, the image-forming lens 12 forms on the imaging plane 3a1 the images of the point light sources on the sample 10 in such a way that the diameters of the airy disks are approximately the same as the sizes of the receiving areas in the pixels respectively. As a result, in an imaging apparatus for low-light sample according to the present embodiment, it is possible to increase the amount of light received by one pixel and electromotive current of one pixel to capture the image of each of the point light sources on the sample 10 high-sensitively with signal-to-noise ratio improved.

The light rays having entered the CCD 3a are photo-electrically converted by the CCD 3a to be output as electronic data of the two-dimensional image which is an observation result, and the electronic data are sent to a personal computer which is not shown in the drawings and the image is displayed on a monitor which is not shown in the drawings.

Besides, in the present embodiment, the aperture stop 11b is formed as a stop the aperture diameter of which is unchanged. However, the aperture stop 11b may be formed in such a way that the numerical apertures NAo and NAi are changed. For example, the aperture stop 11b may be formed as a stop the aperture diameter of which is variable while the stop is arranged on the optical paths on the outside of the objective lens 11.

Also, the objective lens 11 may be removably placed on the body stand 5 so that the objective lens 11 can be changed into an interchangeable objective lens which is different from the objective lens 11 in at least one of focal length and numerical aperture NAi, in accordance with an observation condition for the sample 10 or the like.

Now, as described above, there is a method in which the number of lens components is reduced by making the magnification of an image-forming optical system low so that transmittance of light is increased to raise brightness (NA), as one of methods of observing weak light using a common CCD. However, in the case where the image-forming optical system is made as a telecentric optical system, the focal point position of the image-forming lens has to be located at the position of the rear focal point of the objective lens, so that the reduction of the magnification of the image-forming lens shortens the focal length of the image-forming lens. As a result, an objective lens and the image-forming lens have to be arranged so as to be close to each other.

According to the present applicant's experience, as a condition for observing weak light using a common cooled CCD which is cooled to about −30° C. (minus thirty degrees Celsius), an image-forming lens with a magnification of 0.36× or less is necessary for securing brightness (NA). As a result, the distance f between the principal point of the image-forming lens 12 and the image-forming-lens side lens surface of the objective lens 11 becomes 65 mm or less. Also, in the case where a dichroic mirror having a diameter of 26 mm is used for a light flux diameter of 14.5 mm in a common microscope by taking into consideration the diameter of light flux passing through the image-forming optical system, the distance between the objective lens 11 and the image-forming lens 12 is short, so that it is impossible to arrange between the objective lens 11 and the image-forming lens 12 the dichroic mirror which separates illumination light and fluorescence.

However, in an imaging apparatus for low-light sample of the present embodiment, the fluorescence excitation illumination optical system 2 is formed as a fluorescence transmission illumination optical system so as to radiate to the sample 10 light from the illumination light source 2a with the light from the light source 2a not traveling via the objective lens 11, so that a dichroic mirror does not need to be arranged between the objective lens 11 and the image-forming lens 12 and an enough space to place the emission filter 13 is secured in an imaging apparatus for low-light sample of the present embodiment. The thickness of a common emission filter is about 6 mm and has an enough margin for the distance between the image-forming lens 12 and the object lens 11, so that it is also possible to increase the magnification of the image-forming lens 12.

Also, as described above, if the excitation filter 2d and the emission filter 13 include a plurality of filters which are removably placed on optical paths so that the filters can be changed for one another in accordance with a desired fluorescence wavelength for observation, then it is possible to deal with an observation with a plurality of fluorescent reagents.

As described above, in an imaging apparatus for low-light sample according to the present embodiment, it is possible to perform fluorescence observation by fluorescence transmission illumination, and it is also possible to perform light-emission observation by cutting illumination light by the shutter. Also, it is sufficient to use a single CCD as an image pickup element for fluorescence transmission observation and light-emission observation and there is no necessity to use a plurality of CCDs, so that it is possible to achieve a simple constitution of the apparatus.

Also, an imaging apparatus for low-light sample of the present embodiment is formed as a telecentric optical system and so as to be capable of performing fluorescence transmission observation, so that it is possible to secure so brightness (NA) as to make it possible to perform weak light observation with a common CCD. Specifically, it is possible to achieve a constitution in which the magnification of an image-forming lens is 0.36× or less and the focal length of the image-forming lens is 65 mm or less. As a result, there is no necessity to use an image-forming optical system with a large diameter, and it is possible to form a small apparatus.

An imaging apparatus for low-light sample according to the present invention is useful for fields such as cell biology and molecular biology requiring an observation of a living cell in which a GFP and a luciferase gene is made to work as a reporter of gene expression and a particular portion or a functional protein of the cell is fluorescently or luminescently labeled.

1. An imaging apparatus for low-light sample comprising
an image-forming optical system which includes an objective lens and an image-forming lens and forms the sample image of an sample having a point light source, where the point light source emits weak light which at least includes fluorescence
a fluorescence excitation illumination optical system which radiates light emitted from an illumination light source to the sample to make the sample emit fluorescence, and
an image capturing means which includes a plurality of pixels receiving incident light and captures the image corresponding to the sample image,
wherein the fluorescence excitation illumination optical system is formed in such a way that the fluorescence excitation illumination optical system radiates light emitted from the illumination light source to the sample while the light from the illumination light source does not travel via the objective lens, and
the image-forming optical system is approximately telecentric and is provided with an emission filter which is arranged between the objective lens and the image-forming lens and wavelength-selectively extracts fluorescence emitted from the sample, and the image-forming optical system is formed in such a way that the image-forming optical system collects weak light emitted from the point light source to form airy disks the sizes of which are approximately the same as or smaller than the sizes of the pixels.

2. An imaging apparatus for low-light sample according to claim 1, wherein at least a part of the fluorescence excitation illumination optical system is arranged approximately on the optical axis of the image-forming optical system while an excitation filter is removably placed on the optical paths of the fluorescence excitation illumination optical system, where the excitation filter is capable of wavelength-selectively performing a photoexcitation in accordance with sample, and
the image-forming optical system is formed in such a way that the emission filter is removably placed on the optical paths of the image-forming optical system.

3. An imaging apparatus for low-light sample according to claim 1, wherein the focal length of the image-forming lens is 65 mm or less.

4. An imaging apparatus for low-light sample according to claim 2, wherein the focal length of the image-forming lens is 65 mm or less.
